(19) United States
(12) Patent Application Publication
(10) Pub. No.: US 2026/0056289 A1
(43) Pub. Date: Feb. 26, 2026

(54) RADAR DEVICE AND ESTIMATION METHOD

(71) Applicant: Realtek Semiconductor Corporation, Hsinchu (TW)

(72) Inventors: Min-Hsiang WANG, Hsinchu (TW); Mingzhi GUO, Jiangsu Province (CN); Chang-Ming LEE, Hsinchu (TW); Shau-Yu CHENG, Hsinchu (TW)

(21) Appl. No.: 19/212,714

(22) Filed: May 20, 2025

(30) Foreign Application Priority Data
Aug. 26, 2024 (CN) 202411175659.0
Oct. 22, 2024 (CN) 202411479135.0

(51) Int. Cl. G01S 7/40; G01S 7/35

(52) U.S. Cl. CPC G01S 7/40; G01S 7/352

(57) ABSTRACT

A radar device includes a transmitter and receiver circuit and an estimation circuit. The transmitter and receiver circuit is configured to generate a second signal according to a first signal. The estimation circuit is coupled to the transmitter and receiver circuit and is configured to generate an estimated path delay according to the second signal for a back-end circuit to execute a related application.

### RELATED APPLICATIONS

This application claims priority to Chinese Application Serial Number 202411175659.0, filed Aug. 26, 2024 and Chinese Application Serial Number 202411479135.0, filed Oct. 22, 2024, which is herein incorporated by reference.

### BACKGROUND

### Technical Field

The present disclosure relates to wireless communication technology. More particularly, the present disclosure relates to a radar device and an estimation method that can generate estimated path delay or estimated phase noise.

### Description of Related Art

With developments of technology, various wireless communication devices and related technologies are developed. For example, Wi-Fi radar devices or other wireless communication devices can be used to transmit and receive wireless signals. However, characteristics of these wireless communication devices will affect signal integrity.

### SUMMARY

Some aspects of the present disclosure are to provide a radar device. The radar device includes a transmitter and receiver circuit and an estimation circuit. The transmitter and receiver circuit is configured to generate a second signal according to a first signal. The estimation circuit is coupled to the transmitter and receiver circuit and is configured to generate an estimated path delay according to the second signal for a back-end circuit to execute a related application.

Some aspects of the present disclosure are to provide an estimation method. The estimation method includes following operations: generating, by a transmitter and receiver circuit according to a first signal, a second signal; and generating, by an estimation circuit, an estimated path delay according to the second signal for a back-end circuit to execute a related application.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a radar device according to some embodiments of the present disclosure.

FIG. 2 is a flow diagram of an estimation method according to some embodiments of the present disclosure.

FIG. 3 is a flow diagram of an estimation method according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

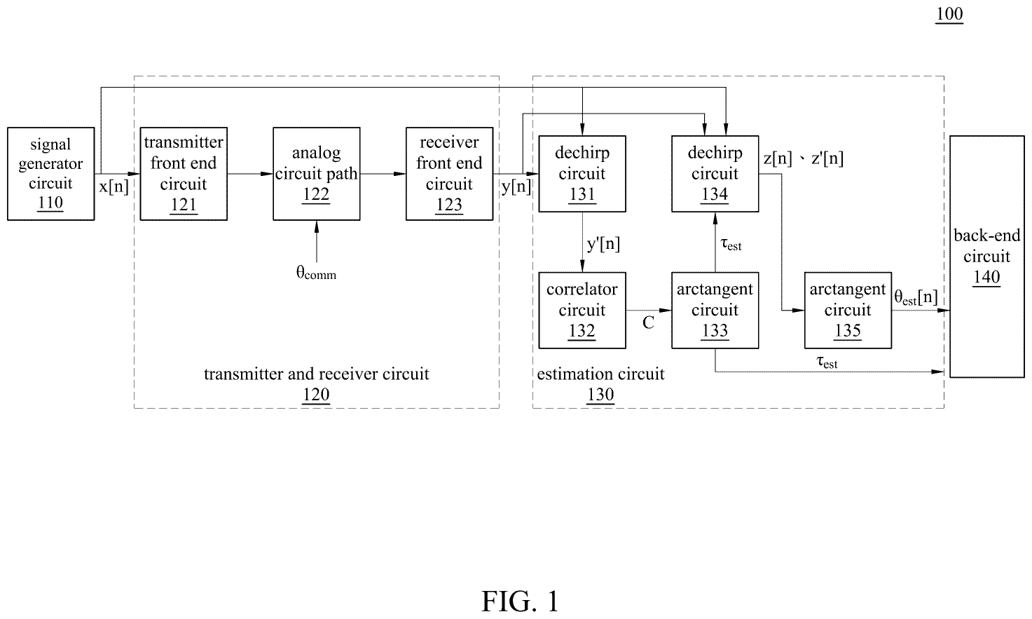

Reference is made to FIG. 1. FIG. 1 is a schematic diagram of a radar device 100 according to some embodiments of the present disclosure. In some embodiments, the radar device 100 can adopt Wi-Fi communication technology to transmit or receive wireless signals, but the present disclosure is not limited thereto.

As illustrated in FIG. 1, the radar device 100 includes a signal generator circuit 110, a transmitter and receiver circuit 120, an estimation circuit 130, and a back-end circuit 140.

Regarding coupling relationship, the signal generator circuit 110 is coupled to the transmitter and receiver circuit 120. The transmitter and receiver circuit 120 is coupled to the estimation circuit 130. The estimation circuit 130 is coupled to the back-end circuit 140.

The signal generator circuit 110 generates a first signal x[n]. The first signal x[n] is a digital signal. The first signal x[n] can be derived by a formula (1) below:

$$x [ n ] = {e}^{j ( 2 π ( ( \frac{µ}{2} ) \times {( n \times {T}_{s} )}^{2} + {f}_{start} \times ( n \times {T}_{s} ) ) )} \qquad ( 1 )$$

wherein

$$2 π ( ( \frac{µ}{2} ) \times {( n \times {T}_{s} )}^{2} + {f}_{start} \times ( n \times {T}_{s} ) )$$

can be defined as θ[n], μ is a slope of the first signal x[n], n is a sampling point index value, Tₛ is a sampling period, and fₛₜₐᵣₜ is a starting frequency of the first signal x[n].

The starting frequency fₛₜₐᵣₜ can be derived by a formula (2) below:

$${f}_{start} = ( \frac{- BW}{2} ) \qquad ( 2 )$$

wherein BW is a bandwidth of the first signal x[n].

The transmitter and receiver circuit 120 includes a transmitter front end circuit 121, an analog circuit path 122, and a receiver front end circuit 123. The transmitter front end circuit 121 is coupled to the analog circuit path 122. The analog circuit path 122 is coupled to the receiver front end circuit 123. The transmitter front end circuit 121 can include a digital to analog converter, a frequency mixer, a power amplify driver, and a power amplifier. The receiver front end circuit 123 can include a low noise amplifier, a frequency mixer, a transimpedance amplifier, and an analog to digital converter. The analog circuit path 122 is a path between one node in the transmitter front end circuit 121 to one node in the receiver front end circuit 123.

The transmitter and receiver circuit 120 generates a second signal y[n] according to the first signal x[n]. The second signal y[n] can be derived by a formula (2) below:

$$y [ n ] = {e}^{j 2 π ( ( \frac{µ}{2} ) \times {( n \times {T}_{s} - τ )}^{2} + {f}_{start} \times ( n \times {T}_{s} - τ ) )} \times {e}^{j {θ}_{comm}} = x [ n ] \times {e}^{j 2 π ( ( \frac{µ}{2} ) \times ( - 2 ( n \times {T}_{s} ) τ + {τ}^{2} ) + {f}_{start} \times ( - τ ) )} \times {e}^{j {θ}_{comm}} \qquad ( 3 )$$

wherein τ is path delay introduced by the transmitter and receiver circuit 120. For example, the transmitter front end circuit 121, the analog circuit path 122, and the receiver front end circuit 123 can include multiple filters (e.g., digital filters) and multiple elements (e.g., analog elements), and these filters and these elements introduce the path delay. θ_{comm} is path noise (or called as shift phase) introduced by the transmitter and receiver circuit 120.

$$2 π ( ( \frac{µ}{2} ) \times ( - 2 ( n \times {T}_{s} ) τ + {τ}^{2} ) + {τ}^{2} ) + {f}_{start} \times ( - τ ) )$$

can be defined as θ_{d}[n]. θ_{d}[n] can represent the phase noise introduced by the path delay.

The estimation circuit 130 includes a dechirp (demodulation) circuit 131, a correlator circuit 132, an arctangent circuit 133, a dechirp circuit 134, and an arctangent circuit 135. The circuits above can be implemented by various logic circuits. The dechirp circuit 131 is coupled to the receiver front end circuit 123 to receive the second signal y[n]. The correlator circuit 132 is coupled between the dechirp circuit 131 and the arctangent circuit 133. The dechirp circuit 134 is coupled between the arctangent circuit 133 and the arctangent circuit 135. The arctangent circuit 135 is coupled to the back-end circuit 140.

In some embodiments, the estimation circuit 130 estimates the path delay introduced by the transmitter front end circuit 121, the analog circuit path 122, and the receiver front end circuit 123 according to the second signal y[n] to generate estimated path delay τₑₛₜ for the back-end circuit 140 to execute related applications.

At first, the dechirp circuit 131 performs a dechirp calculation on the first signal x[n] and the second signal y[n] to generate the third signal y′[n]. The dechirp calculation for generating the third signal y′[n] can be derived by a formula (4) below:

$${y}^{′} [ n ] = x [ n ] \times conj ( y [ n ] ) = {e}^{j 2 π ( ( \frac{μ}{2} ) \times ( 2 ( n \times {T}_{s} ) τ - {τ}^{2} ) + {f}_{start} \times ( τ ) )} \times {e}^{- j {θ}_{comm}} \qquad ( 4 )$$

The sampling period Tₛ needs to satisfy a clock domain of the dechirp circuit 131.

Then, the correlator circuit 132 performs a correlation calculation on the third signal y′[n] to generate a fourth signal C. The correlation calculation for generating the fourth signal C can be derived by a formula (5) below:

$$C = {\sum }_{n = 0}^{N - 1} {y}^{′} [ n + 1 ] \times conj ( {y}^{′} [ n ] ) = {\sum }_{n = 0}^{N - 1} {e}^{j ( 2 \times π \times μ \times {T}_{s} \times τ )} = {Ne}^{j ( 2 \times π \times µ \times {T}_{s} \times τ )} \qquad ( 5 )$$

wherein N is a total quantity of sampling points.

Then, the arctangent circuit 133 performs an arctangent calculation on the fourth signal C to generate the estimated path delay τₑₛₜ. The arctangent calculation for generating the estimated path delay τₑₛₜ can be derived by a formula (6) below:

$${τ}_{est} = \frac{{tan}^{- 1} ( \frac{imag ( C )}{real ( C )} )}{2 \times π \times µ \times {T}_{s}} \qquad ( 6 )$$

wherein imag(C) is an imaginary part of the fourth signal C, and real(C) is a real part of the fourth signal C.

In some embodiments, the arctangent circuit 133 outputs the estimated path delay τₑₛₜ to the back-end circuit 140 through buffers for the back-end circuit 140 to execute related applications. For example, the back-end circuit 140 can be an interference canceller circuit and perform an interference cancellation process according to the estimated path delay τₑₛₜ, but the present disclosure is not limited thereto. The back-end circuit 140 and the related applications can be other circuits and other applications that need this parameter. Thus, performance of the radar device 100 or signal integrity can be improved.

In some embodiments, the estimation circuit 130 further estimates the phase noise introduced by the transmitter front end circuit 121, the analog circuit path 122, and the receiver front end circuit 123 according to the estimated path delay τₑₛₜ to generate estimated phase noise θₑₛₜ[n] for the back-end circuit 140 to execute related applications.

At first, the dechirp circuit 134 performs a dechirp calculation on the first signal x[n], the second signal y[n], and the estimated path delay τₑₛₜ to generate a fifth signal z[n]. The dechirp calculation for generating the fifth signal z[n] can be derived by a formula (7) below:

$$z [ n ] = x [ n - {τ}_{est} ] \times conj ( y [ n ] ) = {e}^{j 2 π ( ( \frac{μ}{2} ) \times ( {( n \times {T}_{s} - {τ}_{est} )}^{2} ) + {f}_{start} \times ( n \times {T}_{s} - {τ}_{est} ) )} \times conj ( {e}^{j 2 π ( ( \frac{µ}{2} ) \times {( n \times {T}_{s} - {τ}_{est} )}^{2} + {f}_{start} \times ( n \times {T}_{s} - {τ}_{est} ) )} \times {e}^{j {θ}_{comm}} ) = {e}^{- j {θ}_{comm}} \qquad ( 7 )$$

Then, the arctangent circuit 135 performs an arctangent operation on the fifth signal z[n] to generate the estimated phase noise θₑₛₜ[n]. The arctangent operation for generating the estimated phase noise θₑₛₜ[n] can be derived by a formula (8) below:

$${θ}_{est} [ n ] = - {tan}^{- 1} ( \frac{imag ( {\sum }_{n = 0}^{N - 1} ( z [ n ] ) )}{real ( {\sum }_{n = 0}^{N - 1} ( z [ n ] ) )} ) \qquad ( 8 )$$

wherein

$$imag ( {\sum }_{n = 0}^{N - 1} ( z [ n ] ) )$$

is an imaginary part of

$$( {\sum }_{n = 0}^{N - 1} ( z [ n ] ) ) , and real ( {\sum }_{n = 0}^{N - 1} ( z [ n ] ) )$$

is a real part of

$$( {\sum }_{n = 0}^{N - 1} ( z [ n ] ) ) .$$

The fifth signal z[n] above does not consider filter response. Accordingly, the derivation result (e^{-jθ}^{_{comm}}) of the formula (7) is irrelevant to the sampling point index value n.

However, there are some filter responses in non-ideal systems. In other words, there are other non-ideal phase noise θₑᵣᵣ[n] relevant to the sampling point index value n. The non-ideal phase noise θₑᵣᵣ[n] is generally contributed by the transmitter front end circuit 121, the analog circuit path 122, and the receiver front end circuit 123.

Accordingly, the fifth signal z′[n] in the non-ideal systems can be derived by a formula (9) below:

$${z}^{′} [ n ] = {e}^{- j ( {θ}_{comm} + {θ}_{err} [ n ] )} \qquad ( 9 )$$

Then, the arctangent circuit 135 performs an arctangent calculation on the fifth signal z′[n] to generate the estimated phase noise θₑₛₜ[n]. The arctangent calculation for generating the estimated phase noise θₑₛₜ[n] can be derived by a formula (10) below:

$${θ}_{est} [ n ] = - {tan}^{- 1} ( \frac{imag ( {\sum }_{n = 0}^{N - 1} ( {z}^{′} [ n ] ) )}{real ( {\sum }_{n = 0}^{N - 1} ( {z}^{′} [ n ] ) )} ) \qquad ( 10 )$$

wherein

$$imag ( {\sum }_{n = 0}^{N - 1} ( {z}^{′} [ n ] ) )$$

is an imaginary part of

$$( {\sum }_{n = 0}^{N - 1} ( {z}^{′} [ n ] ) ) , and real ( {\sum }_{n = 0}^{N - 1} ( {z}^{′} [ n ] ) )$$

is a real part of

$$( {\sum }_{n = 0}^{N - 1} ( {z}^{′} [ n ] ) ) .$$

The purpose of the average calculation above is to improve accuracy so as to reduce the impact of a single sampling point.

In some embodiments, the arctangent circuit 135 outputs the estimated phase noise θₑₛₜ[n] to the back-end circuit 140 through buffers for the back-end circuit 140 to execute related applications. For example, the back-end circuit 140 can be an interference canceller circuit and perform an interference cancellation process according to the estimated phase noise θₑₛₜ[n], but the present disclosure is not limited thereto. The back-end circuit 140 and the related applications can be other circuits and other applications that need this parameter. Thus, performance of the radar device 100 or signal integrity can be improved.

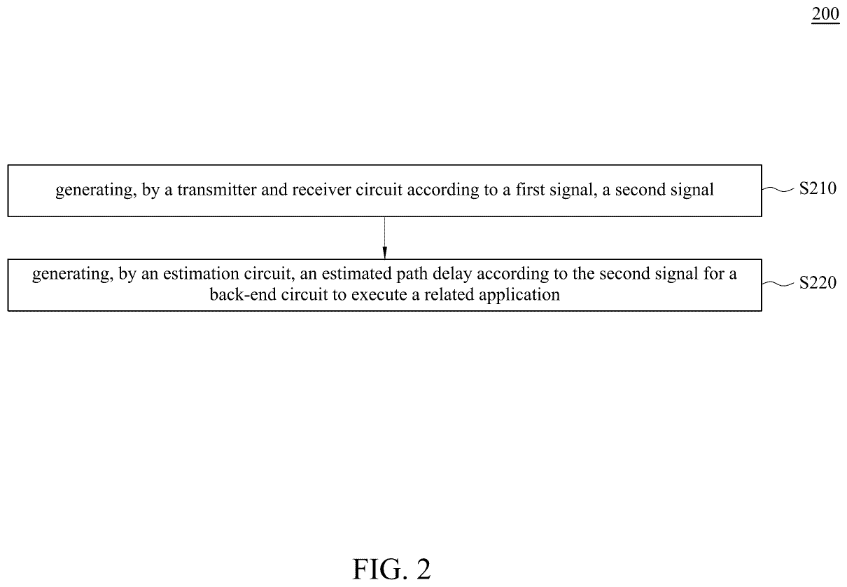

Reference is made to FIG. 2. FIG. 2 is a flow diagram of an estimation method 200 according to some embodiments of the present disclosure.

In some embodiments, the estimation method 200 can be applied to the radar device 100 in FIG. 1, but the present disclosure is not limited thereto. For better understanding, the estimation method 200 is described in following paragraphs with reference to FIG. 1.

The estimation method 200 includes operation S210 and operation S220.

In operation S210, the transmitter and receiver circuit 120 generates the second signal y[n] according to the first signal x[n].

In operation S220, the estimation circuit 130 generates the estimated path delay τₑₛₜ according to the second signal y[n] for the back-end circuit 140 to execute related applications.

Details about operations above are described in aforementioned embodiments, so they are not described herein again.

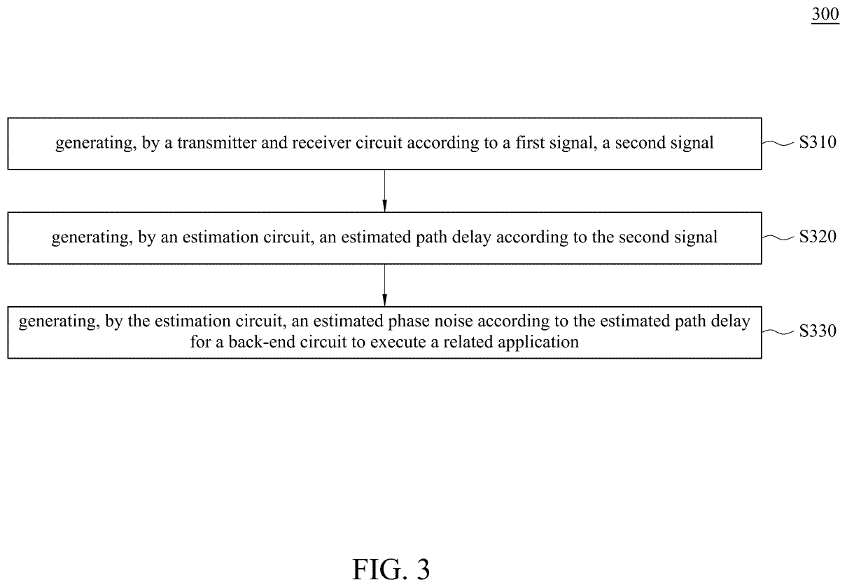

Reference is made to FIG. 3. FIG. 3 is a flow diagram of an estimation method 300 according to some embodiments of the present disclosure.

In some embodiments, the estimation method 300 can be applied to the radar device 100 in FIG. 1, but the present disclosure is not limited thereto. For better understanding, the estimation method 300 is described in following paragraphs with reference to FIG. 1.

The estimation method 300 includes operation S310, operation S320, and operation S330.

In operation S310, the transmitter and receiver circuit 120 generates the second signal y[n] according to the first signal x[n].

In operation S320, the estimation circuit 130 generates the estimated path delay τₑₛₜ according to the second signal y[n].

In operation S330, the estimation circuit 130 generates the estimated phase noise θₑₛₜ[n] according to the estimated path delay τₑₛₜ for the back-end circuit 140 to execute related applications.

Details about operations above are described in aforementioned embodiments, so they are not described herein again.

As described above, in the present disclosure, the estimation circuit can generate the estimated path delay or the estimated phase noise for the back-end circuit to execute the related applications to improve performance of the radar device or signal integrity.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A radar device, comprising:
a transmitter and receiver circuit configured to generate, according to a first signal, a second signal; and
an estimation circuit coupled to the transmitter and receiver circuit and configured to generate an estimated path delay according to the second signal for a back-end circuit to execute a related application.

2. The radar device of claim 1, wherein the estimation circuit comprises:
a dechirp circuit configured to perform a dechirp calculation on the first signal and the second signal to generate a third signal.

3. The radar device of claim 2, wherein the dechirp calculation is as below:
$${y}^{′} [ n ] = x [ n ] \times conj ( y [ n ] )$$
wherein x[n] is the first signal, y[n] is the second signal, y′[n] is the third signal, and n is a sampling point index value.

4. The radar device of claim 2, wherein the estimation circuit further comprises:
a correlator circuit configured to perform a correlation calculation on the third signal to generate a fourth signal.

5. The radar device of claim 4, wherein the correlation calculation is as below:
$$C = {\sum }_{n = 0}^{N - 1} {y}^{′} [ n + 1 ] \times conj ( {y}^{′} [ n ] )$$
wherein N is a total quantity of sampling points, and C is the fourth signal.

6. The radar device of claim 4, wherein the estimation circuit further comprises:
an arctangent circuit configured to perform an arctangent calculation on the fourth signal to generate the estimated path delay.

7. The radar device of claim 6, wherein the arctangent calculation is as below:
$${τ}_{est} = \frac{{tan}^{- 1} ( \frac{imag ( C )}{real ( C )} )}{2 \times π \times μ \times {T}_{s}}$$
wherein μ is a slope of the first signal, Tₛ is a sampling period, τₑₛₜ is the estimated path delay, imag(C) is an imaginary part of the fourth signal, and real(C) is a real part of the fourth signal.

8. The radar device of claim 1, wherein the back-end circuit is an interference canceller circuit and is configured to perform an interference cancellation process according to the estimated path delay.

9. The radar device of claim 1, wherein the estimation circuit comprises:
a dechirp circuit coupled to the transmitter and receiver circuit;
an arctangent circuit configured to output the estimated path delay; and
a correlator circuit coupled between the dechirp circuit and the arctangent circuit.

10. The radar device of claim 1, wherein the transmitter and receiver circuit comprises:
a transmitter front end circuit;
an analog circuit path coupled to the transmitter front end circuit; and
a receiver front end circuit coupled to the analog circuit path,
wherein the estimation circuit is configured to estimate a path delay introduced by the transmitter front end circuit, the analog circuit path, and the receiver front end circuit to generate the estimated path delay.

11. An estimation method, comprising:
generating, by a transmitter and receiver circuit according to a first signal, a second signal; and
generating, by an estimation circuit, an estimated path delay according to the second signal for a back-end circuit to execute a related application.

12. The estimation method of claim 11, further comprising:
performing, by a dechirp circuit in the estimation circuit, a dechirp calculation on the first signal and the second signal to generate a third signal.

13. The estimation method of claim 12, wherein the dechirp calculation is as below:
$${y}^{′} [ n ] = x [ n ] \times conj ( y [ n ] )$$
wherein x[n] is the first signal, y[n] is the second signal, y′[n] is the third signal, and n is a sampling point index value.

14. The estimation method of claim 12, further comprising:
performing, by a correlator circuit in the estimation circuit, a correlation calculation on the third signal to generate a fourth signal.

15. The estimation method of claim 14, wherein the correlation calculation is as below:
$$C = {\sum }_{n = 0}^{N - 1} {y}^{′} [ n + 1 ] \times conj ( {y}^{′} [ n ] )$$
wherein N is a total quantity of sampling points, and C is the fourth signal.

16. The estimation method of claim 14, further comprising:
performing, by an arctangent circuit in the estimation circuit, an arctangent calculation on the fourth signal to generate the estimated path delay.

17. The estimation method of claim 16, wherein the arctangent calculation is as below:
$${τ}_{est} = \frac{{tan}^{- 1} ( \frac{imag ( C )}{real ( C )} )}{2 \times π \times μ \times {T}_{s}}$$
wherein μ is a slope of the first signal, Tₛ is a sampling period, τₑₛₜ is the estimated path delay, imag(C) is an imaginary part of the fourth signal, and real(C) is a real part of the fourth signal.

18. The estimation method of claim 11, wherein the back-end circuit is an interference canceller circuit and is configured to perform an interference cancellation process according to the estimated path delay.

19. The estimation method of claim 11, wherein the estimation circuit comprises:
a dechirp circuit coupled to the transmitter and receiver circuit;
an arctangent circuit configured to output the estimated path delay; and
a correlator circuit coupled between the dechirp circuit and the arctangent circuit.

20. The estimation method of claim 11, wherein the transmitter and receiver circuit comprises:
a transmitter front end circuit;
an analog circuit path coupled to the transmitter front end circuit; and
a receiver front end circuit coupled to the analog circuit path,
wherein the estimation method further comprises:
estimating, by the estimation circuit, a path delay introduced by the transmitter front end circuit, the analog circuit path, and the receiver front end circuit to generate the estimated path delay.
